(19) United States
(12) Patent Application Publication
(10) Pub. No.: US 2018/0060585 A1
(43) Pub. Date: Mar. 1, 2018

(54) SYSTEM FOR PROGRAM COUNTER ENCRYPTION

(71) Applicant: BATTELLE MEMORIAL INSTITUTE, Richland, WA (US)

(72) Inventors: Richard L. Griswold, West Richland, WA (US); William K. Nickless, Richland, WA (US); Ryan C. Conrad, West Richland, WA (US)

(73) Assignee: BATTELLE MEMORIAL INSTITUTE, Richland, WA (US)

(21) Appl. No.: 15/251,458

(22) Filed: Aug. 30, 2016

(51) Int. Cl. G06F 21/56; G06F 21/60; G06F 21/76; H04L 9/08; H04L 9/06

(52) U.S. Cl. CPC G06F 21/567; G06F 21/602; H04L 9/0631; H04L 9/08; G06F 21/76

(57) ABSTRACT

A method and system for protecting a device against return oriented programming attacks by encrypting a central processing unit (CPU) program counter value when storing that value in a software accessible memory and decrypting that value when loading it back into the program counter; whereby alterations to the value will prevent proper decryption and interoperation with the CPU.

The invention was made with Government support under Contract DE-AC05-76RL01830, awarded by the U.S. Department of Energy. The Government has certain rights in the-invention.

### TECHNICAL FIELD

This invention relates to security in electronic systems. More specifically, this invention relates to methods for preventing attacks upon such systems and maintaining the operations of such, a system.

### BACKGROUND OF THE INVENTION

With the wide-spread incorporation of non-executable stacks and other security mechanisms into operating systems, attackers are moving to more complex and subtle attack techniques in order to carry out their attacks. One such technique is the user of “return-oriented programming”, which controls the flow of execution by manipulating parameters and return addresses on a stack. The “return-to-libc-attack”, named for the targeted UNIX runtime library, is one type of return-oriented programming attack. Standard security mechanisms which focus on executable code, such as instruction stream randomization (ISR), are generally ineffective against this type of attack, since it involves manipulation of non-executable data rather than executable code. These attacks can overcome other mechanisms like address-space layout randomization (ASLR) by using techniques such as heap-spraying, NOP sleds, and format string vulnerabilities. ASLR is also ineffective for 32-bit processors, which are widely used in embedded systems, due to a lack of sufficient entropy in the 32-bit address space.

What is needed is a methodology and a system for providing security that is effective against these types of attacks and which is still effective in smaller, less complicated types of systems. Embodiments of the present invention meet these needs.

### SUMMARY Of THE INVENTION

A method and system for protecting a device against return oriented programming attacks by encrypting a central processing unit (CPU) program counter value when storing that value in a software accessible memory and decrypting that value when loading in back into the program counter; whereby alterations to the value will prevent proper decryption and interoperation with the CPU. In various applications and embodiments the methods can further include steps such as isolating items associated with an improper decryption value; generating a new encryption key upon initialization of a central processing unit (CPU), and each time the CPU resets; embedding the modified CPU in a field programmable gate array (FPGA); using a 32-bit program counter; encrypting and decrypting are performed using an exclusive-OR (XOR) operation between the program counter value and a random value that the CPU generates upon initialization, or encrypting and decrypting are performed using strong symmetric key encryption, such as AES, on the program counter value using a key that the CPU generates upon initialization.

The implementation of this methodology can occur through a system having a modified central processing unit (CPU) having a mechanism for generating an encryption key upon initialization of a central processing unit (CPU), a mechanism for performing encryption whenever the CPU saved and loaded the program counter value; and a mechanism for performing decryption whenever the CPU retrieved the encrypted program counter value whereby alterations to the encrypted program value will prevent interoperation of an associated program with the CPU. In various permutations of this system the modified CPU is embedded in a field programmable gate array (FPGA). The program counter value is 32-bits in lengths. The encryption and decryption steps are performed using an exclusive-GR (XOR) operation between the program counter value and a random value that the CPU generates upon initialization and a new encryption key is generated each time the CPU resets.

Various advantages and novel features of the present invention are described herein and will become further readily apparent to those skilled in this art from the following detailed description. In the preceding and following descriptions I have shown and described only the preferred embodiment of the invention, by way of illustration of the best mode contemplated for carrying out the invention. As will be realized, the invention is capable of modification in various respects without departing from the invention. Accordingly, the drawings and description of the preferred embodiment set forth hereafter are to be regarded as illustrative in nature, and not as restrictive.

### BRIEF DESCRIPTION OF THE DRAWINGS

FIG. 1 illustrates a block diagram of the principal method steps of one embodiment of the present invention.

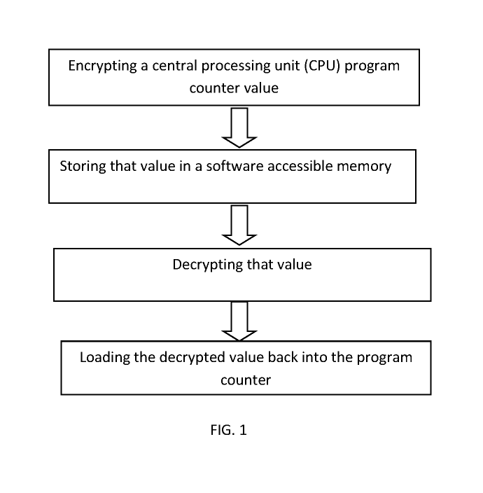

FIG. 2 illustrates a block diagram of the principal method steps of a second portion of present invention.

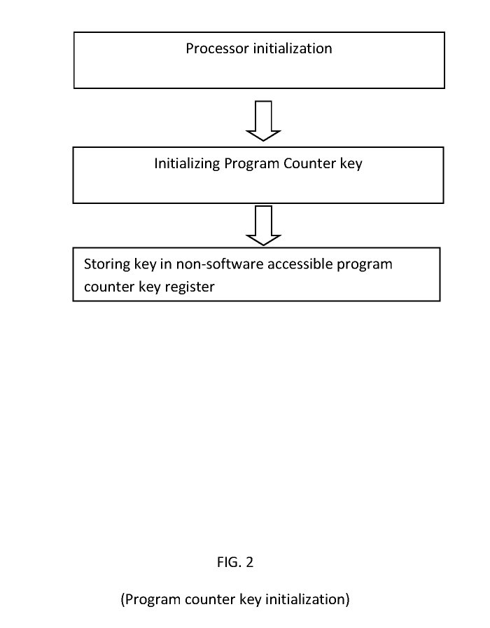

FIG. 3 illustrates a block diagram of the principal method steps of another embodiment of the present invention.

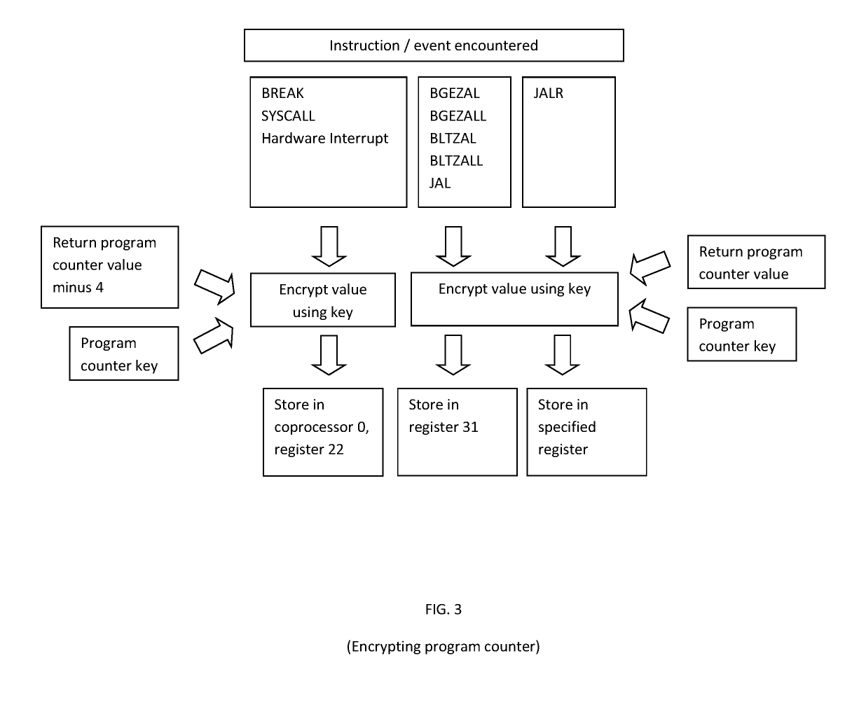

FIG. 4 illustrates a block diagram of the principal method steps of another embodiment of the present invention.

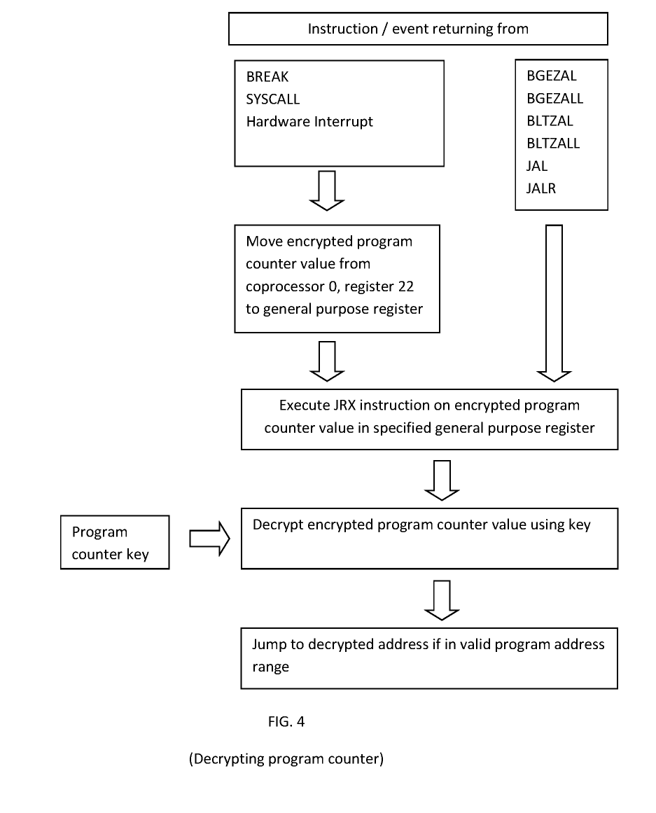

### DETAILED DESCRIPTION OF THE INVENTION

In accordance with one embodiment of the present invention, Program Counter Encryption (PCE) is a described as a method and an implementing system that protects against return-oriented programming attacks and other classes of attacks by manipulating the CPU program counter. With PCE, the CPU encrypts the program counter value whenever it stores it into software-accessible memory or registers. When the CPU later loads the saved value back into the program counter, it decrypts the value. If the value has been tampered with, it will not decrypt properly and the system can take appropriate measures.

A hardware prototype that incorporates this methodology into the CPU has also been developed. For our prototype, we added a mechanism for generating the encryption key upon initialization and a mechanism for performing the encryption and decryption whenever the CPU saved and loaded the program counter value. We have implemented the modified CPU in a field programmable gate array (FPGA) and demonstrated its effectiveness using a variety of tests as well as with a small real-time operating system. The prototype is able to protect the program counter value from tampering, thus preventing data-injection attacks from successfully executing. Performance tests on the prototype show that the processing overhead for PCE is negligible.

Since the CPU may save and load the program counter value frequently, the encryption and decryption must be fast and efficient. For our prototype, we chose a simple encryption scheme that involves performing an exclusive-OR (XOR) operation between the program counter value and a random value that the CPU generates up on initialization. Because the program counter in our prototype is 32 bits in length, the random value used as the encryption key is also 32 bits in length. This algorithm is fast, but it does not pose much resistance to cryptanalysis. However, our prototype implementation generates a new encryption key each time the CPU resets. This helps to mitigate the weakness of the encryption system, since each attack probe will result in a fault and a CPU reset. Our analysis shows that even with the simple XOR-based encryption, the system can hold up under a sustained attack for several days. A symmetric key encryption algorithm such as AES may also be used to increase the resistance to cryptanalysis at the expense of more processing overhead.

In some aspects, PCE is similar to address space layout randomization (ASLR). ASLR randomizes the layout of certain data structures and function entry points, while PCE randomizes the return address from the functions. ASLR provides effective security for 64-bit systems, but not so for 32-bit systems. For 32-bit systems, PCE provides much stronger protection than ASLR.

PCE provides a higher level of protection from attacks that use return-oriented programming techniques on 32-bit processors than other techniques, because it carries more bits of entropy. As mentioned previously, because or restrictions on memory layout, ASLR, a leading technique for protecting against this class of attacks, only has 16 bits of entropy on a 32-bit processor, while PCE has 30 bits of entropy. Since each bit of entropy doubles the number space that an attacker must search, the additional 14 bits of entropy provided by PCE gives it must stronger protection. This allows PCE to be effective for embedded systems that use 32-bit processors.

We have a prototype implementation of system that uses PCE. The prototype system is based on a Plasma soft-core processor running on a Xilinx Spartan-3E FPGA in a Spartan-3E starter board. The Plasma processor is a 32-bit MIPS-1 compatible processor running at 25 MHz. Our prototype uses an Avalon Advanced Encryption Standard (AES) cryptography core to implement a cryptographically secure pseudo-random number generator (CSPRNG). Upon reset, the processor uses the CSPRNG to generate a 32-bit encryption key that it stores in an internal, non-addressable register.

Whenever the processor encounters one of the following instructions or events, it encrypts the return address by performing a bitwise XOR operation between return address and the encryption key:

1 BREAK

1 SYSCALL

1 BGEZAL

1 BGEZALL

1 BLTZAL

1 BLTZALL

1 JAL

1 JALR

1 Hardware interrupt

The processor then stores the encrypted return address in the normal location (co-processor zero, register 14 for the BREAK or SYSCALL instructions or hardware interrupt, specified processor register for JALR instruction or processor register 31 for the remaining instructions). In the case of the BREAK and SYSCALL instructions and hardware interrupts, we modified the processor to also store the encrypted return address minus 4 in co-processor zero, register 22 to allow the handling routines to return to the correct address without needing access to the encryption key to decrypt and manipulate the saved return address. The MIPS-1 instruction set has two return instructions, JR and JALR. However, these instructions may be used in cases where we do not want to decrypt the return address, for example to implement C language “case” statements or function pointers. We added a new return instruction, JRX (Jump Register with Xor), to handle encrypted return addresses. When the processor encounters a JRX instruction, it decrypts the return address in the processor register specified in the instruction by performing a bitwise XOR operation between encrypted return address and the encryption key. The JRX instruction is the same as the JR instruction with the second bit of the “hint” field set to 1. We also modified the GNU Compiler Collection (GCC) toolchain to understand the JRX instruction in assembly code and to replace the JR instruction with JRX when returning from functions.

The Plasma soft-core CPU comes with a custom real-time operating system (RTOS), which we compiled to support PCE. We also planted a vulnerability in the RTOS HTTP server URL parsing routine so we could test the system's response to various attacks. We tested the modified RTOS on both the prototype system and on a software emulator of the prototype system, and in all cases program counter encryption worked as expected. When the attack code attempted to manipulate the program counter, the processor instead jumped to an invalid instruction, which triggered a fault and reset.

Since the system resets and generates a new key after each failed attack attempt we can use the following formula to determine the probability an attack succeeding:

s(α)=1-(1-2-N)α:α≧0

Where α is the number of attempts made and N is the number of effective bits of entropy. The number of effective bits of entropy is the total number of bits, of entropy minus the bit of entropy attacked per attempt. For a single attack, this gives the following probabilities:

1 N=30: 9.313×10−10

1 N=29: 1.863−10−9

1 N=28: 3.725×10−9

1 N=27: 7.451×10−9

1 N=26: 1.490×10−8

1 N=25: 2.980×10−8

1 N=24: 5.960×10−8

1 N=23: 1.192×10−7

1 N=22: 2.384×10−7

1 N=21: 4.768×10−7

1 N=20: 9.537×10−7

Assuming that an attacker can attempt 10 attacks per second, it will take them 1.157 days with 1 million attempts to compromise the system if they can test 10 bits of entropy per attack. This should be a long enough time with enough noise from the attack and subsequent system resets to alert an operator. However, it will most likely take much longer given that 10 attacks per second is too high (it takes longer than 100 ms for the system to reset), and they probably cannot test 10 bits of entropy per attack.

The embodiments described above have broad uses such as, but not limited to critical infrastructure, networking and network equipment providers, embedded control systems, mobile devices, security, and areas that, involve network enabled embedded devices. In the embedded systems space, one specific application would be for smart grid meters, which allow access to the electrical grid infrastructure, and in some cases devices in customers' homes, from a computer network.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

We claim:

1. A method for protecting a device against return oriented programming attacks by encrypting a central processing unit (CPU) program counter value when storing that value in a software accessible memory and decrypting that value when loading it back into the program counter; whereby alterations to the value will prevent proper decryption and interoperation with the CPU.

2. The method of claim 1 further comprising the step of isolating items associated with an improper decryption value.

3. The method of claim 1 further comprising the step of generating a new encryption key upon initialization of a central processing unit (CPU).

4. The method of claim 1 wherein the modified CPU is embedded in a field programmable gate array (FPGA).

5. The method of claim 1 wherein the program counter value is 32-bits in length.

6. The method of claim 1 wherein the encryption and decryption steps are performed using an exclusive-OR (XOR) operation between the program counter value and a random value that the CPU generates up on initialization.

7. The method of claim 1 wherein the encryption and decryption steps are performed using a symmetrical key encryption.

8. The method of claim 7 wherein the symmetrical key encryption methodology is AES.

9. The method of claim 1 wherein a new encryption key is generated each time the CPU resets.

10. A system comprising:
a modified central processing unit (CPU) having a mechanism for generating an encryption key upon initialization of a central processing unit (CPU);
a mechanism for performing encryption whenever the CPU saved and loaded the program counter value; and
a mechanism for performing decryption whenever the CPU retrieved the encrypted program counter value, whereby alterations to the encrypted program value will prevent interoperation of an associated program with the CPU.

11. The system of claim 8 wherein the program counter value is 32-bits in programmable gate array (FPGA).

12. The system of claim 8 wherein the program counter value is 32-bits in length.

13. The system of claim 8 wherein the encryption and decryption steps are performed using an exclusive-OR (XOR) operation between the program counter value and a random value that the CPU generates upon initialization.

14. The system of claim 8 wherein a new encryption key is generated each time the CPU resets.
